(19) United States
(12) Patent Application Publication
(10) Pub. No.: US 2016/0302349 A1
(43) Pub. Date: Oct. 20, 2016

(54) Garden Tool

(71) Applicant: Robert Harper, Iowa Park, TX (US)

(72) Inventor: Robert Harper, Iowa Park, TX (US)

(21) Appl. No.: 14/991,194

(22) Filed: Jan. 8, 2016

Related U.S. Application Data
(60) Provisional application No. 62/147,029, filed on Apr. 14, 2015.

(51) Int. Cl. A01B 1/12; A01B 1/08

(52) U.S. Cl. CPC A01B 1/12; A01B 1/08

(57) ABSTRACT

A garden tool for trimming weeds and cutting through roots and mulch. The garden tool includes an elongated handle having an arcuate configuration, wherein the elongated handle includes a first end and a second end. The first end can be held in a hand of the user and also includes an opening thereon for hanging the garden tool on a hook for storage. The second end includes a tool head thereon, wherein the tool head includes a planar body that tapers from a rear end thereof towards the front end thereof so as to form a point. Further, the side edges of the tool head include a plurality of teeth thereon for use in cutting through weeds. The tapered configuration assists the user in cutting through weeds and digging into the mulch.

### CROSS REFERENCE TO RELATED APPLICATION

This application claims the benefit of U.S. Provisional Application No. 62/147,029 filed on Apr. 14, 2015. The above identified patent application is herein incorporated by reference in its entirety to provide continuity of disclosure.

### BACKGROUND OF THE INVENTION

### Field of the Invention

The present invention relates to garden tools. More specifically, the present invention provides a garden tool for trimming weeds and digging into mulch.

Gardeners typically utilize hoes for shaping soil, trimming weeds, and harvesting root crops. However, hoes having rectangular tool heads do not allow for the user to be precise when trimming or cutting plants. As a result the user may accidentally damage desirable crops and plants while attempting to remove the weeds that have grown adjacent to the crops. Damaging the plant is undesirable and reduces the gardener or farmer's yields. Further, hoes having a conventionally shaped tool head may not effectively break through thick roots and larger clumps of soil. Thus, an improved garden tool is desired so as to allow a user to more easily remove weeds from a garden without damaging nearby plants.

Devices have been disclosed in the prior art that relate to garden tools. These include devices that have been patented and published in patent application publications. These devices generally relate to garden tools resembling hoes having various configurations, such as U.S. Pat. No. 3,643,744, U.S. Published Patent Application Number 2011/0290512, U.S. Design Pat. No. D349835, U.S. Pat. No. 1,832,193, and U.S. Pat. No. 3,545,551.

These prior art devices have several known drawbacks. The devices in the prior art provide hoes having various constructions, but such hoes are not specifically adapted for use in trimming weeds. The hoes in the prior art do not have a tapered tool head with a plurality of teeth thereon for helping to prevent the user from accidentally cutting nearby plants or crops.

In light of the devices disclosed in the prior art, it is submitted that the present invention substantially diverges in design elements from the prior art and consequently it is clear that there is a need in the art for an improvement to existing garden tools. In this regard the instant invention substantially fulfills these needs.

### SUMMARY OF THE INVENTION

In view of the foregoing disadvantages inherent in the known types of garden tools now present in the prior art, the present invention provides a new garden tool wherein the same can be utilized for providing convenience for the user when tending to a garden by removing weeds and digging into soil.

The garden tool comprises an elongated handle having a first end adapted to be held by a user, and a second end having a tool head thereon. The elongated handle comprises an arcuate configuration and includes a curved section adjacent to the tool head. The tool head comprises a substantially pointed front end and includes side portions with a plurality of teeth thereon for facilitating cutting through weeds and soil. The pointed front end can be used to more easily dig into hard soil and to break through roots within the soil.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the garden tool.

FIG. 2 shows a side view of the garden tool.

FIG. 3 shows a planar view of the tool head of the garden tool.

### DETAILED DESCRIPTION OF THE INVENTION

Reference is made herein to the attached drawings. Like reference numerals are used throughout the drawings to depict like or similar elements of the garden tool. For the purposes of presenting a brief and clear description of the present invention, the preferred embodiment will be discussed as used for trimming and removing weeds from a garden without damaging nearby plants. The figures are intended for representative purposes only and should not be considered to be limiting in any respect.

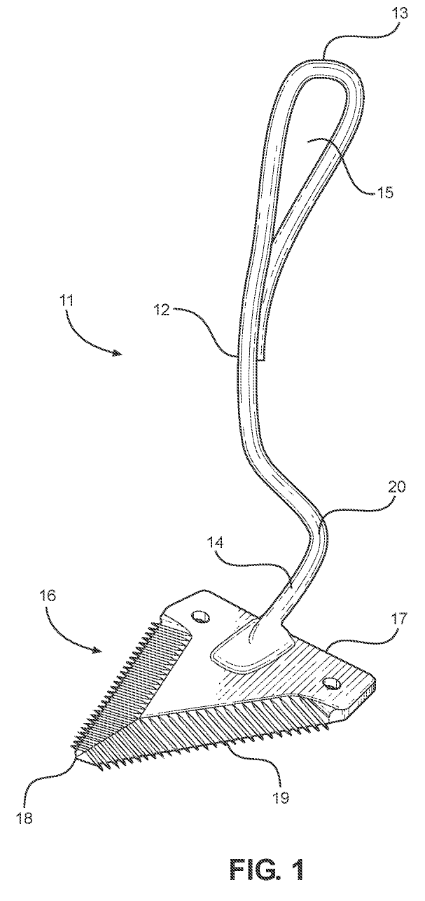

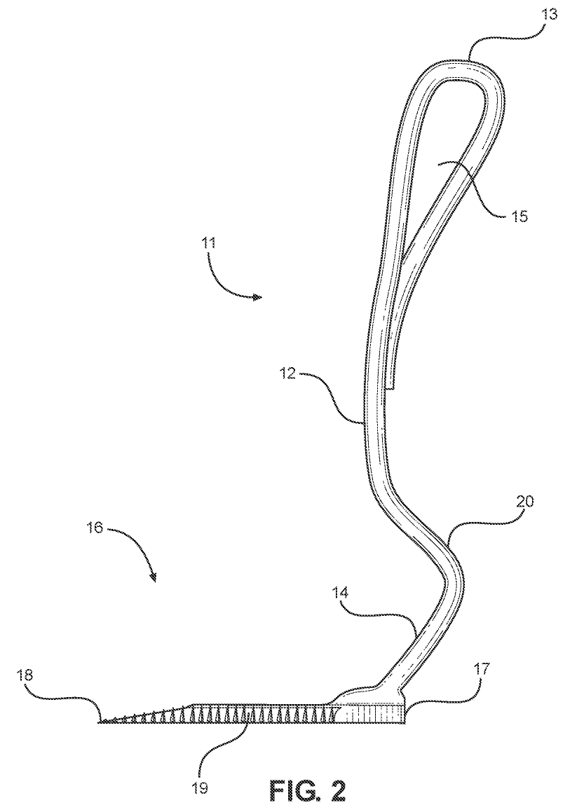

Referring now to FIGS. 1 and 2, there is shown a perspective view of the garden tool and a side view of the garden tool, respectively. The garden tool 11 comprises an elongated handle 12 having a first end 13 and a second end 14. The elongated handle 12 is preferably composed of a durable material, and is preferably composed of a metal. The material is preferably corrosion resistant so that the elongated handle 12 does not easily rust or corrode. The first end 13 of the elongated handle 12 comprises an opening 15 thereon for use in hanging the garden tool 11 from a support structure, such as a hook. The first end 13 is also adapted to be held in the hand of the user so that the user can control and direct the tool.

The second end 14 of the handle 12 is permanently affixed to a tool head 16. The tool head 16 is affixed to the handle 12 such that the tool head 16 is substantially perpendicular to the longitudinal axis of the handle 12, wherein the handle 12 is affixed to an upper surface of the tool head 16. Alternatively, the tool head 16 is affixed to the handle 12 such that the tool head 16 is disposed at other angles relative to the handle 12.

The lower end 14 of the elongated handle 12 comprises a curved section 20 thereon adjacent to the tool head 16. The curved section 20 extends rearward from the tool head 16. In this way, when the tool head 16 is being used, the elongated handle 12 will not contact plants and weeds while the user is working. Further, the angled orientation of the tool head 16 allows the user to obtain greater leverage when digging and removing weeds from the soil.

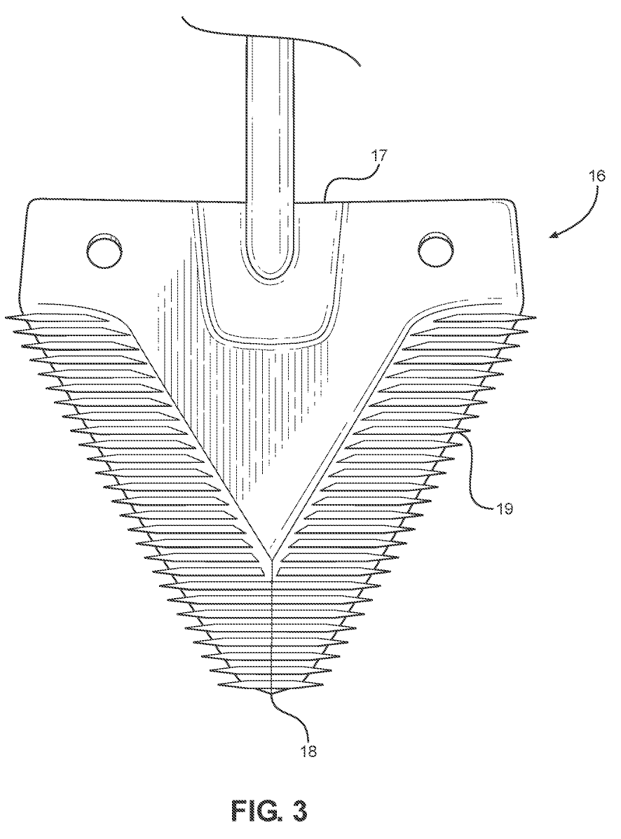

Referring now to FIG. 3, there is shown a planar view of the tool head of the garden tool. The tool head 16 comprises a substantially planar body having a rear end 17 and a front end 18. The tool head 16 tapers from the rear end 17 towards the front end 18 so as to form a point at the front end 18 thereof. In the illustrated embodiment, the tool head 16 comprises a substantially pentagonal configuration. However, in alternate embodiments, the tool head 16 comprises a triangular or spade-shaped configuration. The tapered front end 18 allows the user to more easily cut through weeds and dig into hard soil to break through roots and hard clumps of dirt. Further, the tapered front end 18 allows the user to more accurately direct the tool head 16 towards a particular plant so that a weed can be removed without damaging nearby or adjacent plants.

The sides of the tool head 16 comprise a plurality of teeth 19 thereon. The teeth 19 are sharpened and facilitate cutting of weeds and other plant matter. The teeth 19 extend along the sides of the tool head 16 and are substantially uniform in structure. The teeth 19 preferably extend from the front end 18 of the tool head towards the rear end 17 thereof. In this way, the user can more easily trim weeds without having to repeatedly chop weeds and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A garden tool, comprising:
an elongated handle having a first end and a second end;
a tool head affixed to the second end of the handle, wherein the tool head comprises a body having a rear end, a front end, and side edges;
wherein the front end tapers towards a point;
a plurality of teeth disposed on the side edges of the tool head.

2) The garden tool of claim 1, wherein the tool head comprises a substantially pentagonal shape.

3) The garden tool of claim 1, wherein the tool head comprises a triangular shape.

4) The garden tool of claim 1, wherein the first end of the elongated handle comprises an opening thereon adapted for use in hanging the elongated handle from a support structure.

5) The garden tool of claim 1, wherein the elongated handle comprises an arcuate configuration.

6) The garden tool of claim 1, wherein the elongated handle comprises a curved section adjacent to the lower end thereof.

7) The garden tool of claim 1, wherein the tool head is affixed to the elongated handle in a substantially perpendicular orientation.
